(19) United States
(12) Patent Application Publication
(10) Pub. No.: US 2013/0176405 A1
(43) Pub. Date: Jul. 11, 2013

(54) APPARATUS AND METHOD FOR OUTPUTTING 3D IMAGE

(71) Applicant: Samsung Electronics Co., Ltd., Gyeonggi-do (KR)

(72) Inventors: Moon-Sik JEONG, Gyeonggi-do (KR); Ivan Koryakovskiy, Gyeonggi-do (KR); Sang-Keun Jung, Gyeonggi-do (KR)

(73) Assignee: Samsung Electronics Co., Ltd., Gyeonggi-do (KR)

(21) Appl. No.: 13/718,490

(22) Filed: Dec. 18, 2012

(30) Foreign Application Priority Data
Jan. 9, 2012 (KR) 10-2012-0002627

(51) Int. Cl. H04N 13/04

(52) U.S. Cl. CPC H04N 13/0445
USPC 348/51

(57) ABSTRACT

An apparatus and method are provided for outputting a 3D image in a 3D image display apparatus. Camera information for each of a left virtual camera and a right virtual camera is generated upon receiving image data including a 3D object. Left and right images are generated by applying the generated camera information to the image data. A stereoscopic image is generated and output based on the generated left image and the generated right image

### PRIORITY

This application claims priority under 35 U.S.C. §119(a) to a Korean Patent Application filed in the Korean Intellectual Property Office on Jan. 9, 2012 and assigned Serial No. 10-2012-0002627, the entire disclosure of which is incorporated herein by reference.

### BACKGROUND OF THE INVENTION

1. Field of the Invention

The present invention relates generally to an apparatus and method for outputting three-dimensional (3D) images, and more particularly, to an apparatus and method for outputting different 3D images according to the type of a device that displays stereoscopic images (or 3D images).

2. Description of the Related Art

Amid the increasing market share of 3D televisions (TVs) in the TV market, 3D content that is used for the 3D TVs has been diversified into 3D games, 3D advertising, and 3D movies, for example. 3D display devices that are currently available on the market, such as, for example, 3D TVs, require dedicated 3D glasses, which are classified into either liquid crystal shutter glasses or Film Patterned Retarder (FPR) glasses.

As an alternative, auto-stereoscopic 3D image display devices have been studied, which allow users to view stereoscopic images without wearing dedicated 3D glasses. An example of an auto-stereoscopic 3D image display device includes a 3D Large Format Display (LFD) device. In using the 3D LFD, many users may enjoy 3D images at the same time, without glasses, not only in an interior space, such as a building lobby, but also on a street.

Depth Image-Based Representation (DIBR) may be used to output stereoscopic images on an auto-stereoscopic 3D LFD. DIBR refers to a scheme of representing or rendering 3D images with typical RGB video and depth video, which includes depth information for each RGB image pixel.

However, a 3D LFD is manufactured by a limited number of companies, so its use is limited due to a lack of specialized companies and skilled workers for creating 3D content in the DIBR format. In addition, because of the high price of the 3D LFD devices, small-sized companies may have difficulty in creating 3D content, such as, for example, 3D advertising, with the use of the 3D LFD. Moreover, 3D content represented in DIBR may be played only on the 3D LFD, and there is no way to correct errors which occurred during creation of 3D content, while rendering the defective 3D content in the DIBR. Therefore, it is necessary for 3D display devices to check 3D content in advance online, regardless of their types. If 3D TV, which is cheaper than 3D LFD, can play content for 3D LFD in real time, it will help to make the 3D content market more active. Therefore, content compatibility between 3D LFD and 3D TV is required to expand application of stereoscopic images and increase utilization of 3D content.

### SUMMARY OF THE INVENTION

The present invention has been made to address at least the above problems and/or disadvantages and to provide at least the advantages described below. Accordingly, an aspect of the present invention provides an apparatus and method for efficiently outputting different 3D images according to the type of a 3D display device.

Another aspect of the present invention provides an apparatus and method for outputting 3D images, which are not limited to the type of a 3D display device.

Another aspect of the present invention provides an apparatus and method for allowing DIBR data of an auto-stereoscopic 3D display scheme and 3D images of a stereoscopic 3D display scheme to have the same depth effects.

Another aspect of the present invention provides an apparatus and method for generating and outputting 3D images, which are compatible between 3D LFD and 3D TV.

In accordance with an aspect of the present invention, an apparatus is provided for outputting a 3D image. The apparatus includes a camera information generator for generating camera information for each of a left virtual camera and a right virtual camera upon receiving image data including a 3D object. The apparatus also includes a left-image generator for generating a left image by applying the generated camera information for the left virtual camera to the image data. The apparatus additionally includes a right-image generator for generating a right image by applying the generated camera information for the right virtual camera to the image data. The apparatus further includes a stereoscopic image generator for generating a stereoscopic image based on the generated left image and the generated right image.

In accordance with another aspect of the present invention, a method is provided for outputting a 3D image in a 3D image display apparatus. Camera information for each of a left virtual camera and a right virtual camera is generated upon receiving image data including a 3D object. Left and right images are generated by applying the generated camera information to the image data. A stereoscopic image is generated and output based on the generated left image and the generated right image.

In accordance with a further aspect of the present invention, an article of manufacture is provided for outputting a 3D image in a 3D image display apparatus, including a machine readable medium containing one or more programs which when executed implement the steps of: generating camera information for each of a left virtual camera and a right virtual camera upon receiving image data including a 3D object; generating a left image and a right image by applying the generated camera information to the image data; and generating and outputting a stereoscopic image based on the generated left image and the generated right image.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating an internal structure of a 3D image display apparatus, according to an embodiment of the present invention;

FIG. 2 illustrates images to which DIBR is applied;

FIG. 3 illustrates images to which a scheme of converting DIBR images into stereoscopic images is applied;

FIG. 4 is a flowchart illustrating an operation of a 3D image display apparatus, according to an embodiment of the present invention;

FIG. 5 is a diagram illustrating a scheme of generating view information, according to an embodiment of the present invention;

FIGS. 6A and 6B illustrate images based on the distance between planes in FIG. 5, according to an embodiment of the present invention; and

FIGS. 7A and 7B illustrate images based on the baseline in FIG. 5, according to an embodiment of the present invention.

### DETAILED DESCRIPTION OF EMBODIMENTS OF THE PRESENT INVENTION

Embodiments of the present invention are described in detail below with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Embodiments of the present invention relate to a method for outputting 3D images, which are not limited to the type of a 3D display device. Methods proposed by embodiments of the present invention include, upon receipt of 3D model data including 3D animation, the location of the 3D model data between one or more planes is determined, left and right images are generated by determining left/right virtual camera information, and stereoscopic images are output based on the generated left and right images. As a result, users may view stereoscopic 3D content, which has a similar 3D effect to that of DIBR 3D content, on a 3D LFD, and even on 3D TVs.

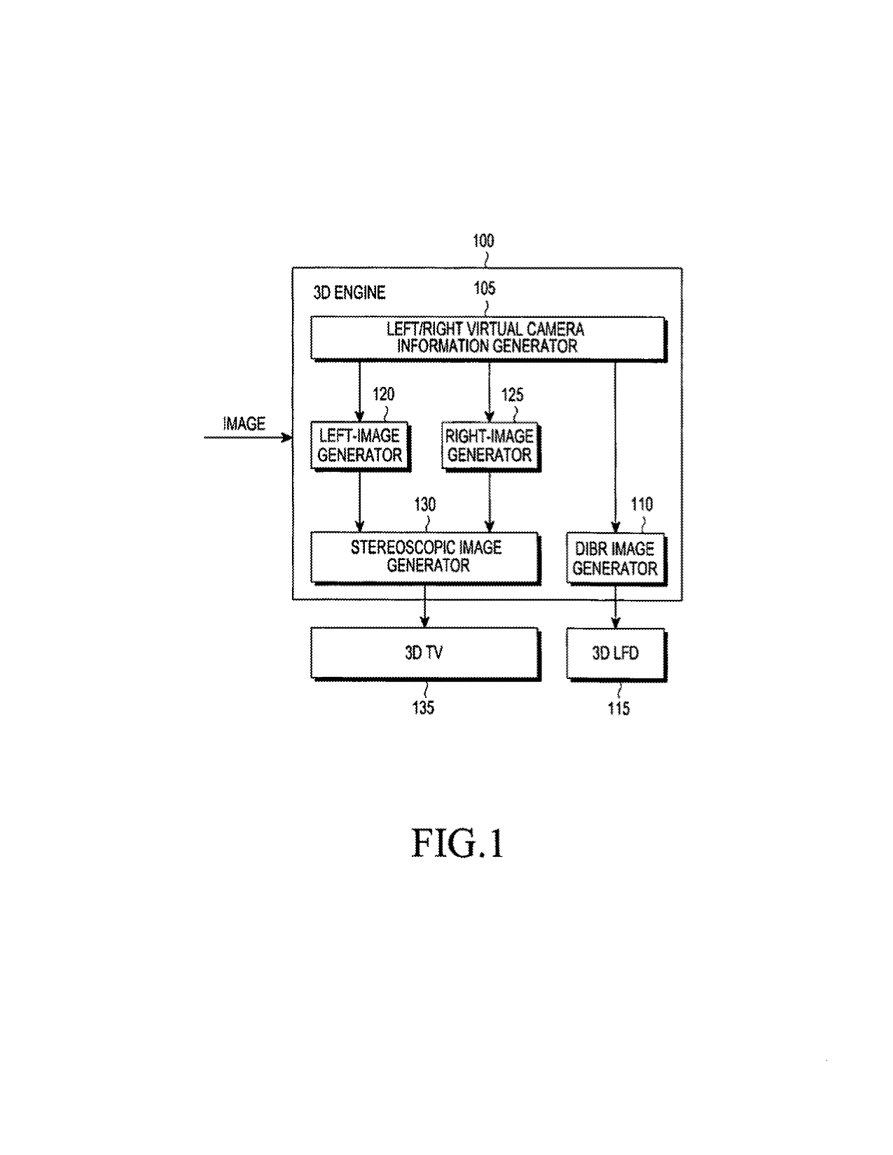

Components of a 3D image display apparatus, proposed by embodiments of the present invention, and operations thereof are described in detail below with reference to FIG. 1.

Referring to FIG. 1, the 3D image display apparatus includes a 3D engine 100 for rendering images, and may include an authoring tool for user input. Stereoscopic images rendered by the 3D engine 100 are output to a 3D TV 135. When a function for generating DIBR images is supported, the 3D engine 100 may output DIBR images to a 3D LFD 115. Although stereoscopic images are assumed to be output to the 3D TV 135 in FIG. 1, by way of example, the stereoscopic images may be output to any other stereoscopic 3D display device, such as, for example, tablet Personal Computers (PCs) and smart phones having a 3D screen. The 3D image display apparatus may be configured to be included in the 3D TV 135.

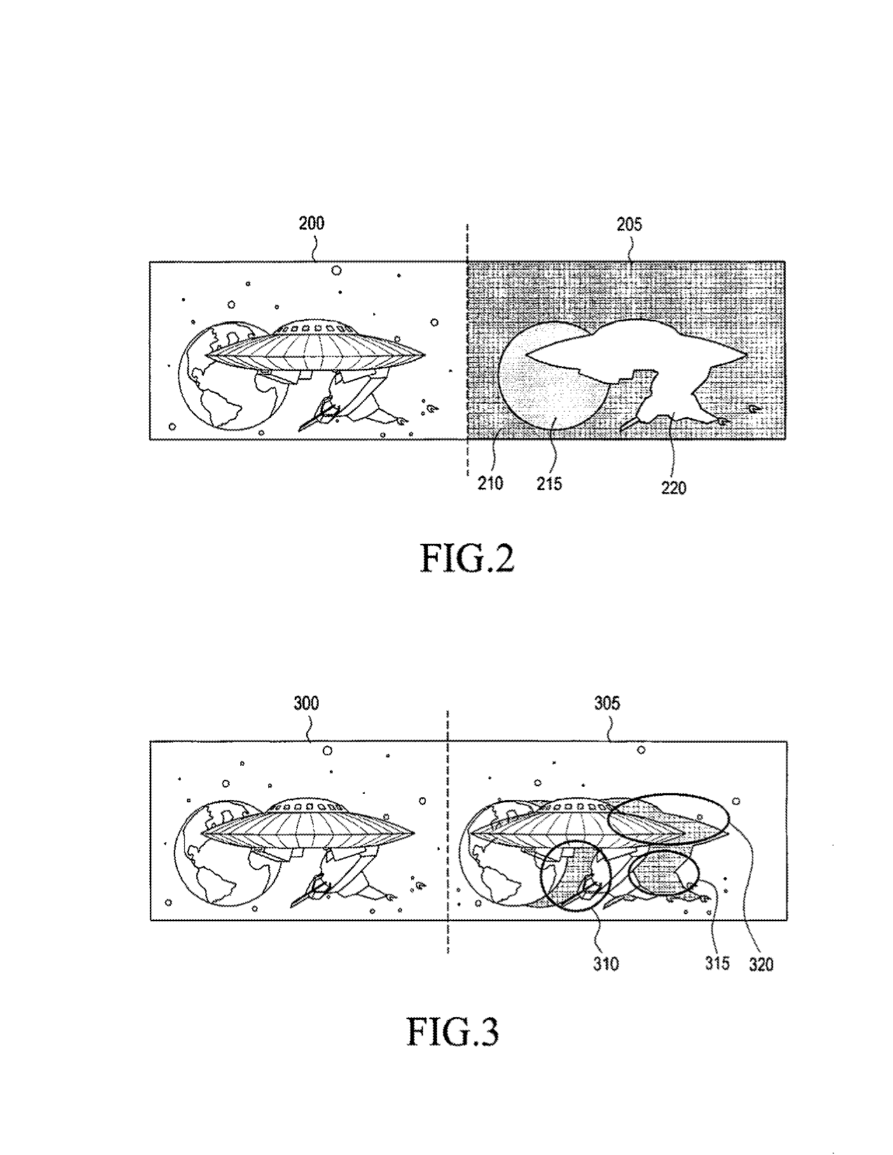

Generally, devices for displaying 3D images, such as, the 3D TV 135 and the 3D LFD 115, have different methods of creating 3D effects. Prior to a description of the present invention, DIBR images are briefly described below, with reference to FIG. 2, for a better understanding of the invention.

Referring to FIG. 2, a DIBR image includes an ordinary RGB texture image 200 and a depth image 205, which includes depth information of the original image (i.e., the RGB texture image 200). The depth image 205 is generally represented as an 8-bit gray image, and as a depth value increases, its distance from the camera decreases. For example, a back plane 210 farthest from the camera has a depth value of 0, a middle plane 215 has a depth value of 127, and a front plane 220 closest to the camera has a depth value of 255. DIBR 3D images are generated through a combination of the original RGB texture image 200 and the depth image 205.

In order to implement the same 3D depth and animation effects as those of the DIBR images on the stereoscopic 3D TV, objects popping out on the 3D LFD will pop out even on the 3D TV. However, it is not possible to implement the same depth and animation effects in DIBR and stereoscopic schemes from the 3D model data. As shown in FIG. 3, if a DIBR 3D image 300 is converted into a stereoscopic 3D image, black holes 310, 315, and 320 are present, which should be filled on a converted 3D image 305.

In addition, 3D effects may be sensed differently depending on the size of the screen, the distance between the user and the 3D image display device, and the distance between user's eyes, for example. Accordingly, it is difficult to convert DIBR 3D images into stereoscopic 3D images on a 1:1 basis. When outputting 3D images on a 3D TV, there is a need to adaptively control the viewing angle and depth of the 3D images so that the 3D images may have the same 3D effects as DIBR images displayed on 3D LFD. Thus, the manner in which parameters of left and right virtual cameras are changed should be determined. A method for determining parameter information of the left and right virtual cameras is described in detail below.

Embodiments of the present invention provide a method for obtaining DIBR images and stereoscopic images having the same effects from 3D model data based on information about one virtual camera and left and right virtual cameras for obtaining DIBR images.

Referring back to FIG. 1, the 3D engine 100 serves to render or represent 3D images on the 3D TV 135, and supports an OpenGL scheme for the rendering. An example of images input to the 3D engine 100 may include, for example, 3D MAX data. These images may be input to the 3D engine 100 through a camera, or the Internet, for example. The 3D engine 100 assigns 3D objects to x, y and z positions in each OpenGL area based on the color image and depth information, for generation of 3D images. The 3D engine 100 may generate stereoscopic images from two left and right virtual cameras using an OpenGL API. The 3D engine 100 includes a left/right virtual camera information generator 105, a DIBR image generator 110, a left-image generator 120, a right-image generator 125, and a stereoscopic image generator 130.

The left/right virtual camera information generator 105 generates left/right virtual camera information including, for example, locations of the left and right virtual cameras, a distance between the left and right virtual cameras, and/or a frustum shift for each virtual camera. The left/right virtual camera information generator 105 shifts a frustum for each virtual camera so that it may have the same view as that in the case where a fixed DIBR camera is used.

The left and right-image generators 120 and 125 generate left and right images by applying their associated parameters generated by the left/right virtual camera information generator 105 to the input image, respectively. The left and right images are delivered to the stereoscopic image generator 130, which generates stereoscopic images based on the left and right images. The stereoscopic images are output to the 3D TV 135, so the user may view 3D images created by the authoring tool.

For one fixed virtual camera, the left/right virtual camera information generator 105 generates information used to obtain DIBR 3D information. Specifically, when generating fixed-camera information, the DIBR image generator 110 generates DIBR images by representing images (e.g., 3D MAX data) with fixed-camera information and depth and color information in the camera information using a DIBR modeler. DIBR images are output to the 3D LFD 115.

Accordingly, stereoscopic images may be displayed on the 3D TV 135 even though they are rendered in DIBR, so the user may adjust the positions of planes online using the authoring tool to sense the 3D effects if he or she is unsatisfactory with the output results of the 3D images. As a result, the use of the proposed scheme makes it possible to easily and quickly correct 3D content even during playback thereof. In addition, embodiments of the present invention may adaptively change the positions of planes, facilitating easy creation of 3D images.

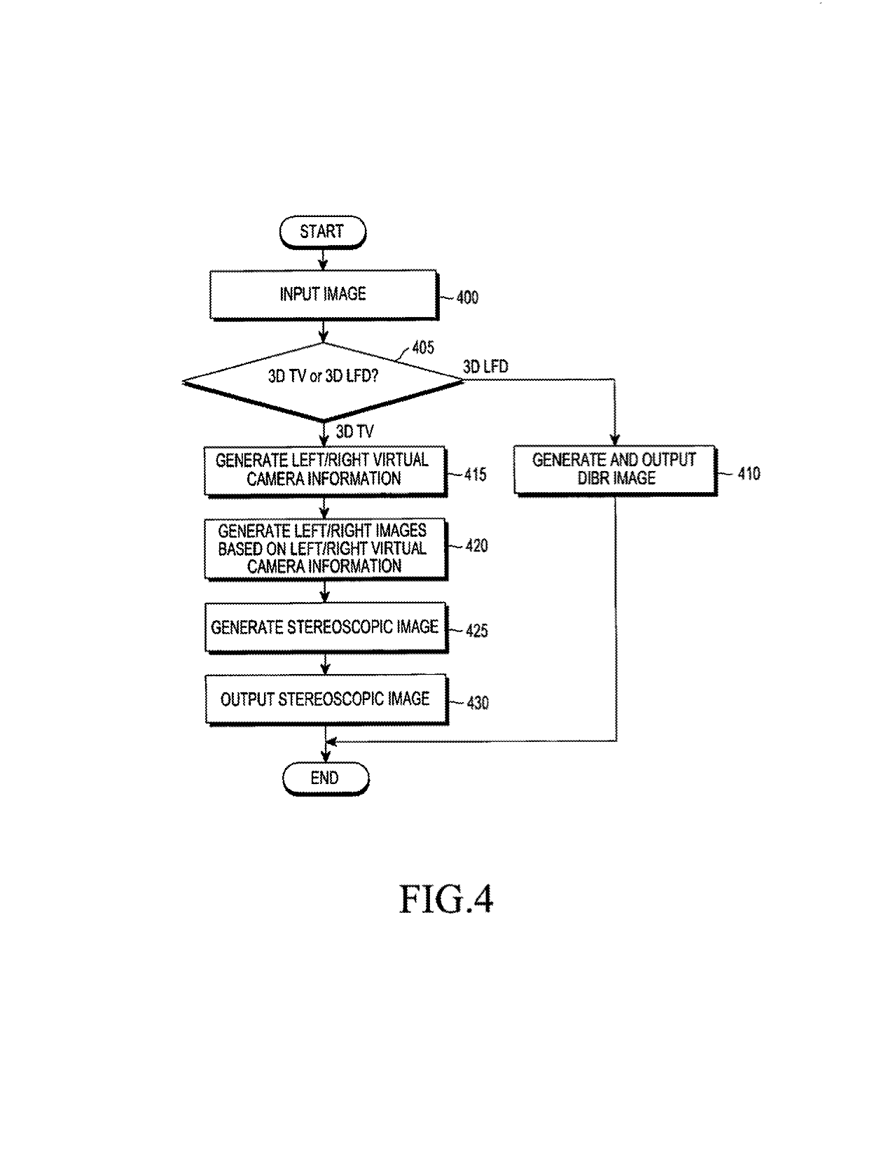

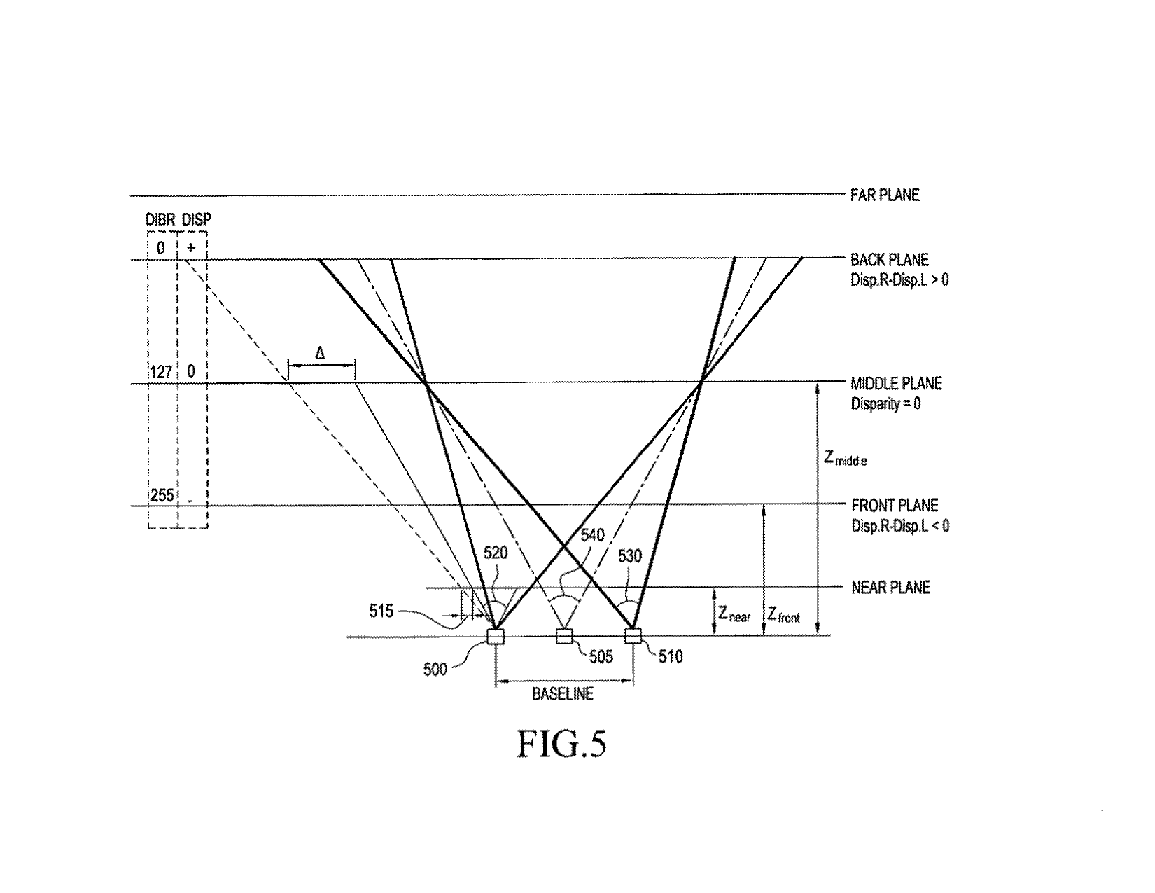

FIG. 4 is a flow diagram illustrating an operation of a 3D image display apparatus according to an embodiment of the present invention. The operation illustrated in FIG. 4 is described with reference to FIGS. 5, 6A, 6B, 7A and 7B.

Referring to FIG. 4, upon receiving an image including 3D objects in step 400, the 3D image display apparatus determines whether it will output the received image on a 3D TV or a 3D LFD, in step 405. The user may decide to output the image on the 3D TV, if he or she wants to check 3D images for the 3D LFD during creation thereof. However, if the user wants to output 3D images on the 3D LFD, or, if the user does not decide to preview the 3D images on the 3D TV, the 3D image display apparatus generates DIBR images and outputs the generated DIBR images to the 3D LFD, in step 410. This process of generating and outputting DIBR images corresponds to the general DIBR modeling step and rendering step. In addition, the process of generating DIBR images in step 410 may be omitted, when the user wants to enjoy the same 3D effects as those on the 3D LFD even on the 3D TV, though the 3D LFD is not mounted in the 3D image display apparatus.

If the user decides to output the 3D images on the 3D TV, the 3D image display apparatus generates left/right virtual camera information, in step 415. The left/right virtual camera information may be determined by applying an OpenGL rendering function.

A method of generating the left/right virtual camera information is described with reference to FIG. 5. The present invention generates left/right virtual camera information taking into account the point at which it is possible to match a middle plane at views of the DIBR scheme and the stereoscopic scheme.

Referring to FIG. 5, in the case of the DIBR scheme, image data includes one or more layers, such as, for example, a front plane, a middle plane, and a back plane. Information about a fixed virtual camera 505 is used to create DIBR images. The information about the fixed virtual camera 505 includes a location and a frustum of the fixed virtual camera 505. The frustum refers to a view area defined by the fixed virtual camera 505, such as a Field Of View (FOV) 540 and a focal length of the fixed virtual camera 505. The FOV refers to a view angle from the camera view.

In accordance with an embodiment of the present invention, in the case of the stereoscopic scheme, the locations of the front plane, middle plane and back plane may be designated and, if necessary, changed by the user during rendering. In the DIBR scheme, the front plane corresponds to a plane with a depth value of 255, the middle plane corresponds to a plane with a depth value of 127, and the back plane corresponds to a plane with a depth value of 0. In addition, a far plane and a near plane correspond to planes with a set OpenGL camera value, and may be defined by a 3D content creator. The near plane is a plane closest to the view and the far plane is a plane farthest from the view.

In the stereoscopic scheme, left/right virtual camera information applied to left and right images includes locations of left and right virtual cameras 500 and 510, a distance between the left and right virtual cameras 500 and 510, and a frustum shift 515 for each virtual camera. The distance between the left and right virtual cameras 500 and 510 is defined herein as a baseline.

The left and right virtual cameras 500 and 510 are not substantially the same in the frustum, and a frustum shift is determined by Equation (1) below.

$$FrustumShift = Δ \frac{{z}_{near}}{{z}_{middle}} \qquad ( 1 )$$

In equation (1), Z_{middle} represents a distance from the virtual cameras to the middle plane, Zₙₑₐᵣ represents a distance from the virtual cameras to the near plane, and Δ=0.5×Baseline.

If all 3D objects on the front plane are assumed to have a specific disparity defined by the left and right virtual cameras 500 and 510, the specific disparity is referred to as Baseline′. In this case, a relationship between the two baselines Baseline′ and Baseline may be defined as in Equation (2) below.

$$Baseline = {Baseline}^{′} \frac{{z}_{middle}}{{z}_{middle} - {z}_{near}} \qquad ( 2 )$$

In Equation (2), Baseline′ may be a specific value, e.g., any one of 1, 0.9 and 1.1. Baseline′ may adaptively vary depending on the size of 3D TV.

If Baseline in Equation (2) is substituted into Equation (1), the frustum shift may be rewritten as Equation (3) or Equation (4).

$$\begin{matrix}FrustumShift = \frac{1}{2} \cdot \frac{{z}_{near}}{{z}_{middle} - {z}_{front}} \cdot {Baseline}^{′} & ( 3 ) \\ Δ = \frac{1}{2} \cdot \frac{{z}_{middle}}{{z}_{middle} - {z}_{near}} \cdot {Baseline}^{′} & ( 4 )\end{matrix}$$

If an OpenGL rendering function is applied as above, not only the frustum shift, but also the locations of the left and right virtual cameras, and the distance between the left and right virtual cameras may be determined for each virtual camera, making it possible to determine left/right virtual camera information.

Referring back to FIG. 4, if the left/right virtual camera information is generated in this way, the 3D image display apparatus generates left and right images, which correspond to 3D objects viewed from the left and right virtual cameras, respectively, based on the left/right virtual camera information, in step 420. Thereafter, the 3D image display apparatus generates stereoscopic images based on the generated left and right images in step 425, and outputs the stereoscopic images to the 3D TV in step 430.

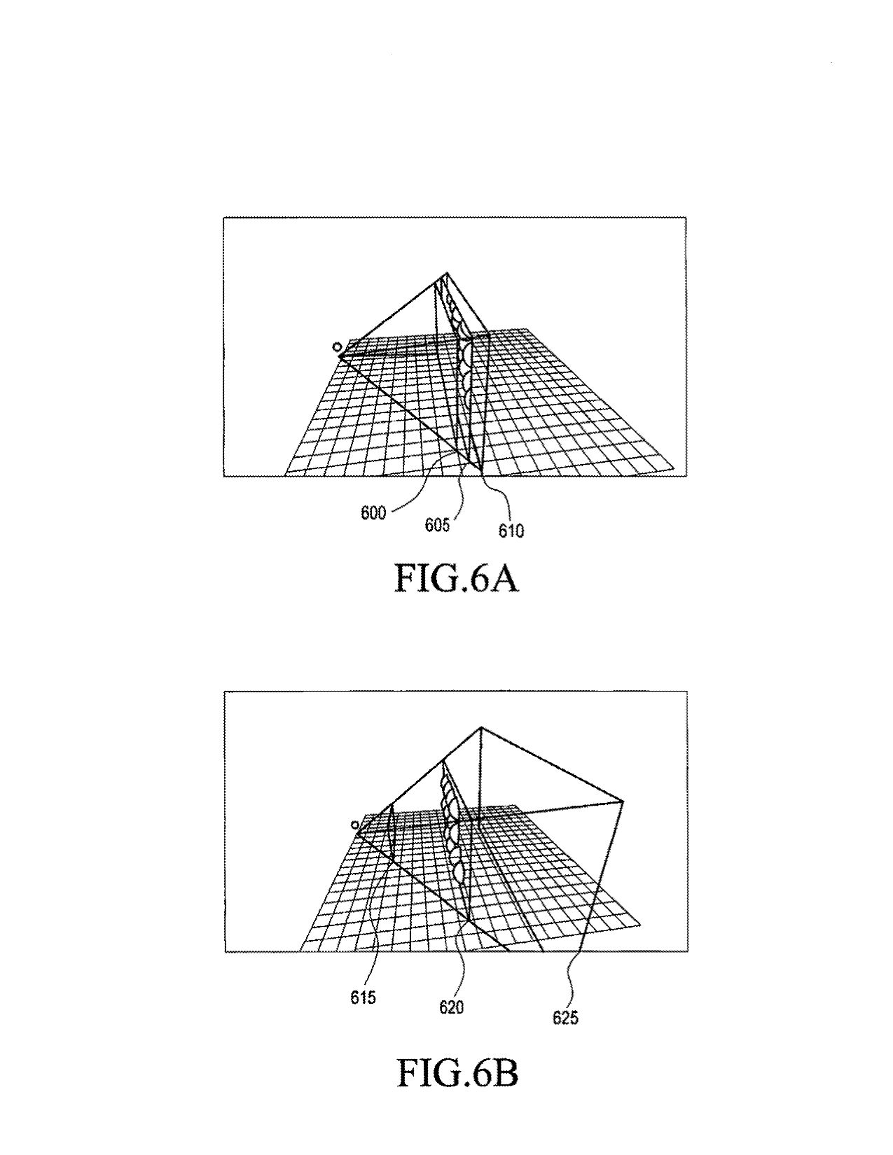

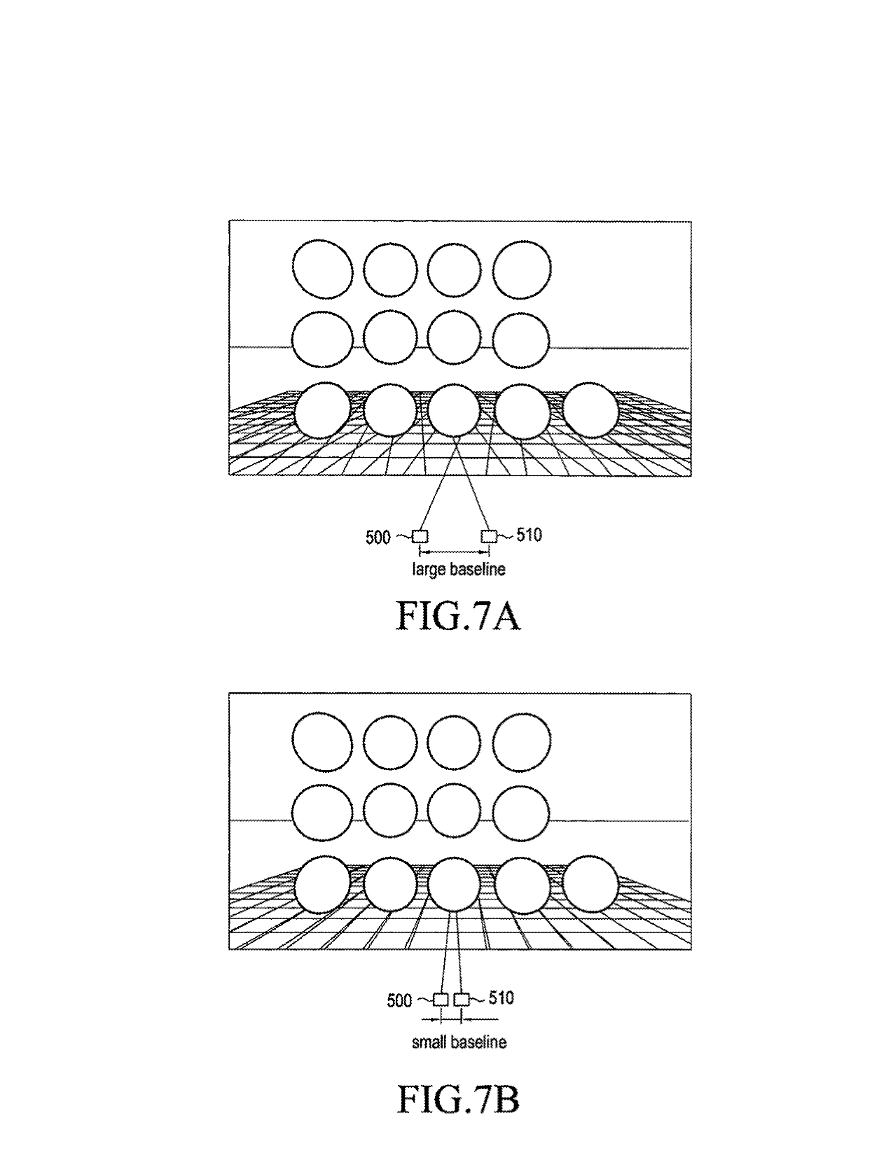

FIG. 6A illustrates a case where the distance between planes 600, 605 and 610 is short, and FIG. 6B illustrates a case where the distance between planes 615, 620 and 625 is relatively long. FIG. 7A illustrates a 3D image in a case where the baseline between the left and right virtual cameras 500 and 510 is long and the distance between the planes is short, and FIG. 7B illustrates a 3D image in a case where the baseline between the left and right virtual cameras 500 and 510 is short and the distance between the planes is long. Although the 3D effects may be felt differently depending on the change in distance between the planes and the length of the baseline, the user may feel the same 3D effects for the DIBR images and the stereoscopic images no matter where the planes are located, as shown in FIGS. 6A and 6B.

In the examples above, a 3D engine may be implemented in 3D TV, and the 3D engine may be a controller in 3D TV or a functional module included in the controller.

As is apparent from the foregoing description, the novel 3D image display apparatus proposed by embodiments of the present invention may play content for 3D LFD in real time, even on the 3D TV which is relatively cheaper than the 3D LFD, making the 3D content market more active. In addition, the 3D image display apparatus allows the user to view 3D content on the 3D TV in advance before playing the 3D content on the 3D LFD, facilitating easy and fast processing. Moreover, the proposed 3D image display apparatus may allow the DIBR data for the auto-stereoscopic 3D display device and the 3D images for the stereoscopic 3D display device to have the same depth effects.

Embodiments of the present invention may be implemented in the form of hardware, software, or a combination of the hardware and software. The software may be stored for example, in a nonvolatile storage device such as a Read Only Memory (ROM), whether erasable or re-writable, or for example, in a memory (e.g., a Random Access Memory (RAM)), a memory chip, a device or an Integrated Circuit (IC), or for example, in a storage medium which is optically or magnetically recordable and is readable by machine, such as a Compact Disc (CD), a Digital Versatile Disc (DVD), a magnetic disc, and magnetic tape. It can be understood that a memory, which is mountable in the 3D TV, is a mere example of a storage medium which is suitable to store a program including instructions implementing embodiments of the present invention, and is readable by machine. Therefore, the present invention includes a program including codes for implementing the apparatus and method set forth in claims of this specification, and a storage medium which stores the program and is readable by machine (e.g., computer). In addition, the program may be electronically transferred through any medium such as communication signals, which are transmitted by wire or wireless connection, and the prevention invention may properly include all equivalents thereto.

While the invention has been shown and described with reference to certain embodiments thereof, it will be understood by those skilled in the art that various changes in form and detail may be made therein without departing from the spirit and scope of the invention as defined by the appended claims and their equivalents.

What is claimed is:

1. An apparatus for outputting a three-dimensional (3D) image, comprising:
a camera information generator for generating camera information for each of a left virtual camera and a right virtual camera upon receiving image data comprising a 3D object;
a left-image generator for generating a left image by applying the generated camera information for the left virtual camera to the image data;
a right-image generator for generating a right image by applying the generated camera information for the right virtual camera to the image data; and
a stereoscopic image generator for generating a stereoscopic image based on the generated left image and the generated right image.

2. The apparatus of claim 1, wherein the camera information for each of the left virtual camera and the right virtual camera comprises at least one of locations of each of the left virtual camera and the right virtual camera, a distance between the left virtual camera and the right virtual camera, and a frustum shift for each of the left virtual camera and the right virtual camera.

3. The apparatus of claim 2, wherein the frustum shift for each of the left virtual camera and the right virtual camera is determined based on a rendering function, which is based on a distance from the location of each virtual camera to a near plane, a distance from the location of each virtual camera to a middle plane, a distance from the location of each virtual camera to a front plane, and a distance between the left virtual camera and the right virtual camera.

4. The apparatus of claim 3, wherein the middle plane corresponds to a plane with a Depth Image-Based Representation (DIBR) depth value of 127, and the front plane corresponds to a plane with a DIBR depth value of 255.

5. The apparatus of claim 1, wherein the camera information for each of the left virtual camera and the right virtual camera is determined by applying an OpenGL rendering function.

6. The apparatus of claim 1, wherein the image data comprises one or more layers comprising a front plane, a middle plane and a back plane, and the apparatus further comprises an authoring tool, which allows a user to designate locations of a front plane, a middle plane and a back plane.

7. The apparatus of claim 1, further comprising a 3D TV for outputting the stereoscopic image.

8. The apparatus of claim 1, wherein the image data is 3D MAX data.

9. The apparatus of claim 1, further comprising an image generator for generating a DIBR image based on information about a fixed virtual camera upon receiving the information about the fixed virtual camera for determining DIBR 3D information, from the camera information generator.

10. The apparatus of claim 9, further comprising a 3D Large Format Display (LFD) for outputting the generated DIBR image.

11. A method for outputting a three-dimensional (3D) image in a 3D image display apparatus, comprising:
generating camera information for each of a left virtual camera and a right virtual camera upon receiving image data comprising a 3D object;
generating a left image and a right image by applying the generated camera information to the image data; and
generating and outputting a stereoscopic image based on the generated left image and the generated right image.

12. The method of claim 11, wherein the camera information for each of the left virtual camera and the right virtual camera comprises at least one of locations of each of the left virtual camera and the right virtual camera, a distance between the left virtual camera and the right virtual camera, and a frustum shift for each of the left virtual camera and the right virtual camera.

13. The method of claim 12, wherein the frustum shift for each of the left virtual camera and the right virtual camera is determined based on a rendering function, which is based on a distance from the location of each virtual camera to a near plane, a distance from the location of each virtual camera to a middle plane, a distance from the location of each virtual camera to a front plane, and a distance between the left virtual camera and the right virtual camera.

14. The method of claim 13, wherein the middle plane corresponds to a plane with a Depth Image-Based Representation (DIBR) depth value of 127, and the front plane corresponds to a plane with a DIBR depth value of 255.

15. The method of claim 11, wherein the camera information for each of the left virtual camera and the right virtual camera is determined by applying an OpenGL rendering function.

16. The method of claim 11, wherein the image data is 3D MAX data.

17. An article of manufacture for outputting a three-dimensional (3D) image in a 3D image display apparatus, comprising a machine readable medium containing one or more programs which when executed implement the steps of: generating camera information for each of a left virtual camera and a right virtual camera upon receiving image data comprising a 3D object;
generating a left image and a right image by applying the generated camera information to the image data; and
generating and outputting a stereoscopic image based on the generated left image and the generated right image.
